(19) United States
(12) Patent Application Publication
(10) Pub. No.: US 2013/0234925 A1
(43) Pub. Date: Sep. 12, 2013

(54) METHOD AND APPARATUS FOR PERFORMING AN OPERATION AT LEAST PARTIALLY BASED UPON THE RELATIVE POSITIONS OF AT LEAST TWO DEVICES

(71) Applicant: David A. Dearman, San Bruno, CA (US)

(72) Inventor: David A. Dearman, San Bruno, CA (US)

(73) Assignee: NOKIA CORPORATION, Espoo (FI)

(21) Appl. No.: 13/416,247

(22) Filed: Mar. 9, 2012

(51) Int. Cl. G09G 5/00

(52) U.S. Cl. 345/156

(57) ABSTRACT

A method, apparatus and computer program product are provided in order to facilitate the provision of user input intended to cause an operation to be performed. In the context of a method, a position of a second device relative to a first device is determined. The position of the second device is non-overlapping relative to the first device. The method also performs an operation, with a processor, based at least partially upon the position of the second device relative to the first device. A corresponding apparatus and computer program product are also provided.

### TECHNOLOGICAL FIELD

An example embodiment of the present invention relates generally to the utilization of two or more devices to affect an operation performed by one of the devices and, more particularly, to the performance of an operation by a device based upon the relative positions of two or more devices.

### BACKGROUND

The operations performed by mobile terminals, such as cellular telephones, personal digital assistants (PDAs), laptop computers, tablet computers or the like, may be based upon user input. In this regard, the user input may provide directions or selections that govern at least some of the operations performed by the mobile terminal. For example, a user may select a media file, such as a video file, an audio file or the like, to be played by the mobile terminal such that a user may watch the video, listen to the audio or the like. In this example, user input may be provided in order to commence playing of the media file, to stop the playing of the media file or to take any other action with respect to the presentation of the media file, such as fast-forwarding or rewinding of the media file.

The user input is typically received by the mobile terminal in the form of one or more keystrokes entered via a conventional keypad, one or more touch inputs entered, for example, via a touch sensitive display or via one or more gestures performed by the user and detected by the mobile terminal. In regards to the entry of keystrokes or touch inputs, a user may have to focus upon relatively small keys or regions of a touch sensitive display in order to insure that the proper input is provided. In some instances, such as in instances in which the user is distracted or is otherwise unable to pay full attention to the entry of the user input or in instances in which the user has only a limited period of time in which to provide the user input, such as in an instance in which an incoming voice call will be transferred to voicemail following a predetermined time period, the user may have difficulty providing the desired user input and, therefore, may have difficulties causing the desired operation to be performed by the mobile terminal.

While these and other forms of user input allow a user to control at least some of the operations performed by a mobile terminal, users may sometimes have difficulties recalling the specific type of input that is required in order to cause a particular operation to be performed. Accordingly, user input that is more intuitive with respect to the operation that is to be performed may have a greater likelihood of being successfully remembered by a user who desires to cause the operation to be performed.

### BRIEF SUMMARY

A method, apparatus and computer program product are therefore provided in accordance with an example embodiment of the present invention in order to facilitate the provision of user input intended to cause an operation to be performed. In this regard, the method, apparatus and computer program product of an example embodiment may cause an operation to be performed by a first device based upon the relative positions of the first device and a second device. As such, a user may provide input with respect to the performance of an operation in accordance with an example embodiment to the present invention by positioning the first and second devices and without having to enter keystrokes or touch input. In some embodiments, the method, apparatus and computer program product may cause the performance of an operation based upon the relative positions of two or more devices in a manner that is intuitive and, therefore, potentially more memorable for the user.

In one embodiment, a method is provided that includes determining a position of a second device relative to a first device. The position of the second device is non-overlapping relative to the first device. The method of this embodiment also performs an operation, with a processor, based at least partially upon the position of the second device relative to the first device.

By way of example, the performance of the operation may include the identification of a category of operations based upon the position of the second device relative to the first device. Thus, the method of this example embodiment may also include receiving a selection of the operation within the category and performing the operation selected from within the category. In this regard, the identification of the category of operations may include causing a plurality of candidate operations to be presented such that the receipt of the selection includes receiving the selection of a respective candidate operation.

The method of one embodiment may also include determining movement of the second device relative to the first device from a first non-overlapping position to a second non-overlapping position. In this embodiment, the performance of the operation may include performing the operation based, not only upon the relative position of the first and second devices, but also at least partially upon the movement of the second device relative to the first device. The method of one embodiment may also include causing information to be transmitted to the second device. In one embodiment, the method may also include receiving a signal from the second device via a proximity-based communication protocol. As such, the determination of the position of the second device relative to the first device in accordance with this embodiment may include determining the position of the second device relative to the first device based at least partially upon the signal.

In another embodiment, an apparatus is provided that includes at least one processor and at least one memory storing computer program code with the at least one memory and the computer program code configured to, with the processor, cause the apparatus to at least determine a position of a second device relative to a first device. The position of the second device is non-overlapping relative to the first device. The at least one memory and the computer program code of one embodiment are also configured to, with the processor, cause the apparatus to perform an operation based at least partially upon the position of the second device relative to the first device.

By way of example, the at least one memory and the computer program code of one embodiment are also configured to, with the processor, cause the apparatus to perform the operation by identifying a category of operations based upon the position of the second device relative to the first device. Thus, the at least one memory and the computer program code of this embodiment may also be configured to, with the processor, cause the apparatus to receive a selection of the operation within the category and perform the operation selected from within the category. In this regard, the at least one memory and the computer program code may be configured to, with the processor, cause the apparatus to identify the category of operations by causing a plurality of candidate operations to be presented and to receive the selection by receiving the selection of a respective candidate operation.

The at least one memory and the computer program code of one embodiment are also configured to, with the processor, cause the apparatus to determine movement of the second device relative to the first device from a first non-overlapping position to a second non-overlapping position. In this embodiment, the at least one memory and the computer program code may be configured to, with the processor, cause the apparatus to perform the operation by performing the operation based, not only upon the relative position of the first and second devices, but also at least partially upon the movement of the second device relative to the first device. The at least one memory and the computer program code of one embodiment may also be configured to, with the processor, cause the apparatus to cause information to be transmitted to the second device. In one embodiment, the at least one memory and the computer program code may also be configured to, with the processor, cause the apparatus to receive a signal from the second device via a proximity-based communication protocol. As such, the at least one memory and the computer program code may also be configured to, with the processor, cause the apparatus to determine the position of the second device relative to the first device by determining the position of the second device relative to the first device based at least partially upon the signal.

In a further embodiment, a computer program product is provided that includes at least one non-transitory computer-readable storage medium having computer-executable program code portions stored therein with the computer-executable program code portions including program instructions configured to determine a position of a second device relative to a first device. The position of the second device is non-overlapping relative to the first device. The computer-executable program code portions also include program instructions configured to perform an operation based at least partially upon the position of the second device relative to the first device.

By way of example, the program instructions configured to perform the operation may include program instructions configured to identify a category of operations based upon the position of the second device relative to the first device. Thus, the computer-executable program code portions of this example embodiment may also include program instructions configured to receive a selection of the operation within the category and perform the operation selected from within the category. In this regard, the program instructions configured to identify the category of operations may include program instructions configured to cause a plurality of candidate operations to be presented and the program instructions configured to receive the selection may include program instructions configured to receive the selection of a respective candidate operation.

The computer-executable program code portions of one embodiment also include program instructions configured to determine movement of the second device relative to the first device from a first non-overlapping position to a second non-overlapping position. In this embodiment, the program instructions configured to perform the operation may include program instructions configured to perform the operation based, not only upon the relative position of the first and second devices, but also at least partially upon the movement of the second device relative to the first device. The computer-executable program code portions of one embodiment also include program instructions configured to cause information to be transmitted to the second device. In one embodiment, the computer-executable program code portions also include program instructions configured to receive a signal from the second device via a proximity-based communication protocol. As such, the program instructions configured to determine the position of the second device relative to the first device in accordance with this embodiment may include program instructions configured to determine the position of the second device relative to the first device based at least partially upon the signal.

In yet another embodiment, an apparatus is provided that includes means for determining a position of a second device relative to a first device. The position of the second device is non-overlapping relative to the first device. The apparatus of this embodiment also includes means for performing an operation based at least partially upon the position of the second device relative to the first device.

### BRIEF DESCRIPTION OF THE DRAWINGS

Having thus described certain example embodiments in general terms, reference will now be made to the accompanying drawings, which are not necessarily drawn to scale, and wherein:

FIG. 1 is a block diagram illustrating an apparatus that may be specifically configured in accordance with an example embodiment of the present invention;

FIG. 2 is a flowchart illustrating operations performed in accordance with an example embodiment of the present invention;

FIG. 3 is a perspective view illustrating the relative positions of first and second devices;

FIG. 4 is a perspective view illustrating first and second devices having different relative positions;

FIG. 5 is a flowchart illustrating operations performed in accordance with another example embodiment of the present invention;

FIG. 6 is a perspective view illustrating movement between the first and second devices and the resulting relative position between the first and second devices;

FIG. 7 is a perspective view illustrating one example of non-overlapping movement between the first and second devices and the resulting relative position between the first and second devices; and

FIG. 8 is a flowchart illustrating operations performed in accordance with a further example embodiment of the present invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

In accordance with an example embodiment of the present invention, a method, apparatus and computer program product are provided to receive user input in the form of the user's relative positioning of at least two devices such that the performance of an operation is based upon the relative position of devices. As such, the method, apparatus and computer program product of an example embodiment may leverage the plurality of devices utilized by at least some users and may cause one of the devices to perform an operation based upon the relative position of two or more of the devices. Various types of devices may be utilized in conjunction with the determination of their relative position and the corresponding performance of an operation based at least in part upon the relative position. At least one of the devices may be a mobile terminal that is configured for movement by the user relative to the other device. As such, the mobile terminal may be embodied in any of a variety of manners including as a mobile communication device such as a mobile telephone, PDA, pager, laptop computer, tablet computer, or any of numerous other hand held or portable communication devices, computation devices, content generation devices, content consumption devices, or combinations thereof. The other device may also be a mobile terminal and, as such, may be embodied, for example, by any of the devices described above. However, the other device may alternatively be a fixed device, such as a personal computer, a work station or other type of computing device that is a fixed in position, either permanently or at least temporarily. While the method, apparatus and computer program product of an example embodiment will be described hereinbelow in regards to the provision of user input through the relative position of a pair of devices, other embodiments of a method, apparatus and computer program product may be configured to receive user input based upon the relative positions of three or more devices.

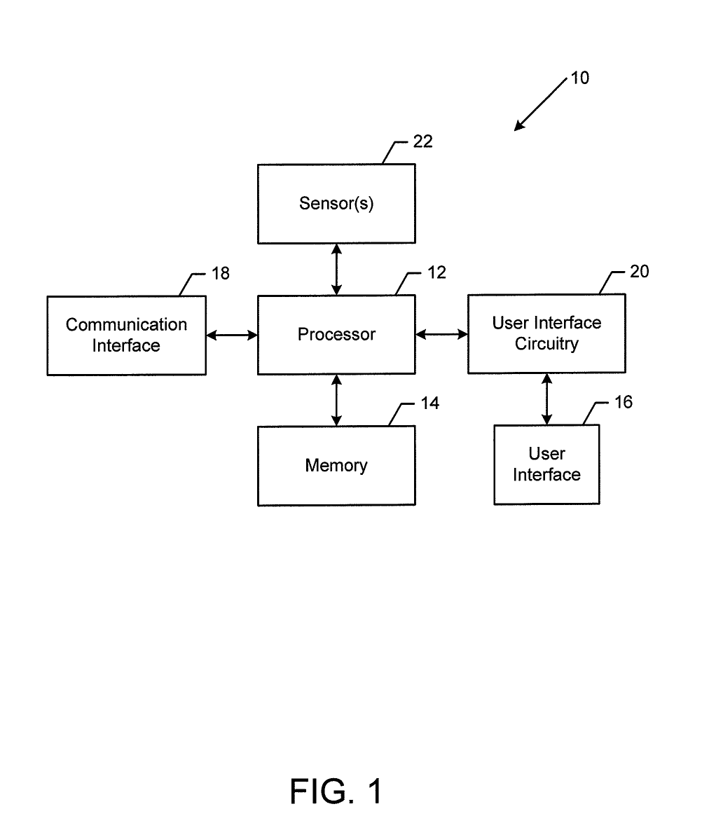

Regardless of its mobility, the apparatus of an example embodiment is depicted in FIG. 1 and may include various means, such as a processor 12, memory 14, communication interface 16, user interface 18, user interface circuitry 20 and sensor(s) 22, for performing the various functions herein described. These means of the apparatus as described herein may be embodied as, for example, hardware elements (e.g., a suitably programmed processor, combinational logic circuit, and/or the like), a computer program product comprising computer-readable program instructions (e.g., software or firmware) stored on a computer-readable medium (e.g. memory) that is executable by a suitably configured processing device (e.g., the processor), or some combination thereof.

The processor 12 may, for example, be embodied as various means including one or more microprocessors with accompanying digital signal processor(s), one or more processor(s) without an accompanying digital signal processor, one or more coprocessors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1 as a single processor, in some embodiments the processor comprises a plurality of processors. In an example embodiment, the processor is configured to execute instructions stored in the memory 14 or otherwise accessible to the processor. These instructions, when executed by the processor, may cause the apparatus to perform one or more of the functionalities of the mobile terminal as described herein. As such, whether configured by hardware or software methods, or by a combination thereof, the processor may represent an entity configured to perform operations according to embodiments of the present invention when configured accordingly. Thus, for example, when the processor is embodied as an ASIC, FPGA or the like, the processor may comprise specifically configured hardware for conducting one or more operations described herein. Alternatively, as another example, when the processor is embodied as an executor of instructions, the instructions may specifically configure the processor to perform one or more algorithms and operations described herein.

The memory 14 may include, for example, non-transitory volatile and/or non-volatile memory. Although illustrated in FIG. 1 as a single memory, the memory may comprise a plurality of memories. The memory may comprise volatile memory, non-volatile memory, or some combination thereof. In this regard, the memory may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory may be configured to store information, data, applications, instructions, or the like for enabling the mobile terminal to carry out various functions in accordance with some example embodiments of the present invention. For example, in at least some embodiments, the memory is configured to buffer input data for processing by the processor 12. Additionally or alternatively, in at least some embodiments, the memory is configured to store program instructions for execution by the processor. The memory may store information in the form of static and/or dynamic information.

The communication interface 16 may be embodied as any device or means embodied in hardware, a computer program product comprising computer readable program instructions stored on a computer readable medium (e.g., the memory 14) and executed by a processing device (e.g., the processor 12), or a combination thereof that is configured to receive and/or transmit data from/to a remote device over a network. In this regard, the communication interface may be configured to transceive data over a public land mobile network (PLMN) network (e.g., a cellular network implementing universal mobile telecommunications service (UMTS) terrestrial radio access network (UTRAN), evolved UTRAN (E-UTRAN) and/or long term evolution (LTE) standards) operated by a network operator. Additionally or alternatively, the communication interface may be configured to transmit and receive data over a wireless local area network (WLAN). Still further, the communication interface may be configured to transmit and receive information or other signals via a proximity-based communication protocol, such as via Wi-Fi, near field communications (NFC), BlueTooth, worldwide interoperability for microwave access (WiMAX) or the like, so as to support communications between other proximately-located devices. In at least one embodiment, the communication interface is at least partially embodied as or otherwise controlled by the processor. In this regard, the communication interface may be in communication with the processor, such as via a bus. The communication interface may include, for example, an antenna, a transmitter, a receiver, a transceiver and/or supporting hardware or software for enabling communications with other entities of the system. The communication interface may be configured to receive and/or transmit data using any protocol that may be used for communications between computing devices of the system. The communication interface may additionally be in communication with the memory and/or user interface 18, such as via a bus.

The user interface 18 may be in communication with the processor 12 to receive an indication of a user input and/or to provide an audible, visual, mechanical, or other output to a user. As such, the user interface may include, for example, a keyboard, a mouse, a joystick, a display, a touch screen display, a microphone, a speaker, and/or other input/output mechanisms. The user interface may be in communication with the memory 14 and/or communication interface 16, such as via a bus. The processor and/or user interface circuitry 20, embodied in one embodiment by the processor, may be configured to control one or more functions of one or more elements of the user interface through computer program instructions (e.g., software and/or firmware) stored on a memory accessible to the processor and/or the user interface circuitry.

As shown in FIG. 1, the apparatus 10 may also include one or more sensors 20. The apparatus may include various types of sensors including, for example, one or more position sensors, e.g., a global positioning system (GPS), for determining the position of the apparatus and/or one or more accelerometers, one or more motion sensors or the like for detecting motion of the apparatus and the direction of any such motion about two or more mutually orthogonal axes.

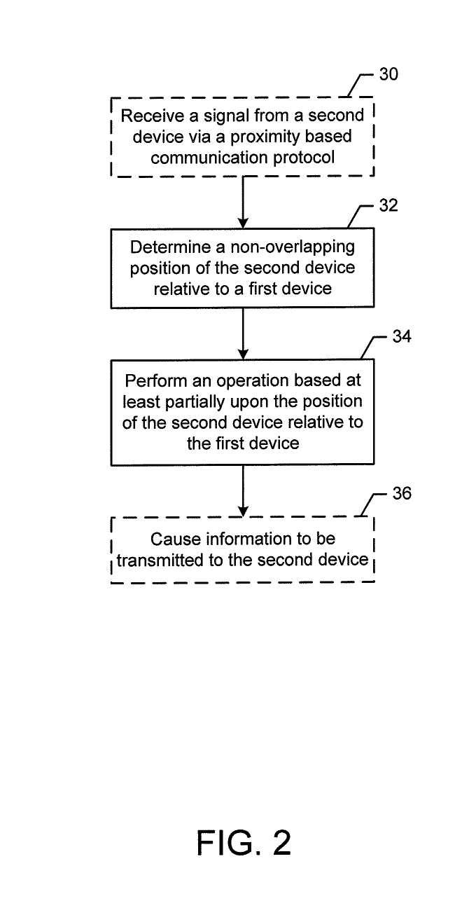

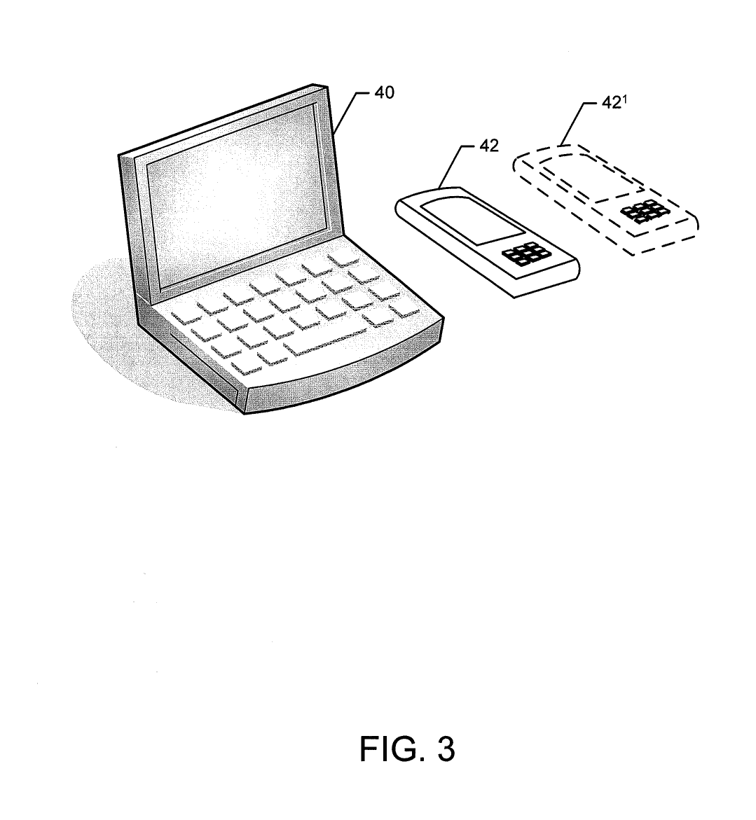

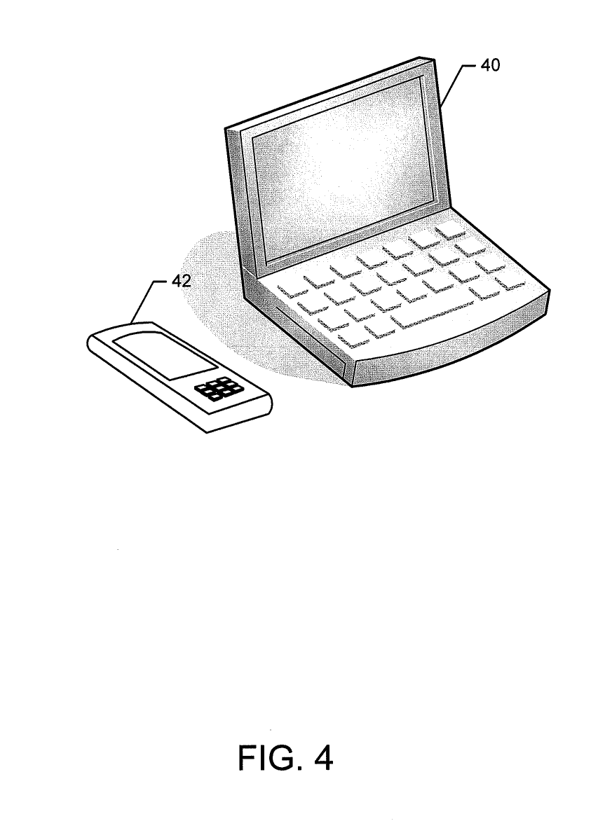

Referring now to FIG. 2, the operations performed by an apparatus 10 configured in accordance with an example embodiment of the present invention are shown. In this regard, the apparatus may include means, such as the processor 12, the sensor(s) 22 or the like, for determining a non-overlapping position of the second device relative to the first device. See block 32 of FIG. 2. By way of example, FIG. 3 depicts a first device embodied by a laptop computer 40 and a second device embodied by a cellular telephone 42. In this example, the second device embodied by the cellular telephone is positioned proximate to, but on the right side of the first device embodied by the laptop computer. The second device is in a non-overlapping position relative to the first device. In one embodiment, the non-overlapping position is a non-display-overlapping position in which no portion of the second device overlies or otherwise overlaps any portion of the display of the first device, while in another embodiment, the non-overlapping position is a non-user interface-overlapping position in which no portion of the second device overlies or otherwise overlaps any portion of the user interface of the first device, such as the keypad and display of the laptop computer in FIG. 3. Still further, the non-overlapping position may be defined in accordance with one embodiment so that no portion of the second device overlies any portion of the first device, as shown, for example, in FIGS. 3 and 4. Indeed, the second device of the example depicted in FIG. 3 not only fails to overlap the first device, but is spaced apart from the first device while remaining in proximity to the first device. By way of a further example, FIG. 4 depicts the second device embodied as a mobile telephone positioned on the left of the first device embodied as a laptop computer and therefore having a different relative position than that shown in FIG. 3.

The apparatus 10, such as the processor 12, the sensor(s) 22 or the like, may determine the non-overlapping position of the second device relative to the first device in a variety of different manners. For example, the apparatus may be configured to determine an instance in which at least one other device is positioned proximate to the apparatus. For example, in some embodiments, the apparatus may include means, such as the processor, the communication interface or the like, for receiving a signal or other indication from another device that at least one other device is proximate the apparatus. See block 30 of FIG. 2. In this regard, the apparatus, such as the processor, the communication interface or the like, may be configured to transmit signals to and/or receive signals from other devices, such as through a proximity-based communications, e.g., Wi-Fi, NFC, BlueTooth, Wi-MAX, etc. In such a manner, the apparatus may be configured to recognize the proximate nature of other devices based on the ability to transmit signals to and/or receive signals from the other devices, such as by recognizing signals having a strength and/or a quality that satisfy respective thresholds as being proximate the apparatus.

In some embodiments, the apparatus 10, such as the processor 12, the sensor(s) 22 or the like, may be configured to determine the distance to the other devices during the determination of the non-overlapping position of the second device relative to the first device. For example, the apparatus, such as the processor, may be configured to determine the distance between the apparatus and the other devices based on characteristics of the signal (e.g., time traveled, signal strength, signal quality, etc.). By way of example, the second device embodied as a mobile telephone is shown to be closer to the laptop computer 40 in the solid line representation designated 42 than in the dashed line representation designated 42′.

In addition to determining proximity of and distance to one or more other devices, the apparatus 10, such as the processor 12, may determine the relative position of each other device. Although the relative position may be determined in various manners, each other device of one embodiment may transmit a position signal to the apparatus. The position signal may provide the specific location of the other device such that the apparatus, such as the processor, may determine the relative position of the other device based upon the position of the other device and the position of the apparatus as provided, for example, by a position sensor. Additionally or alternatively, the apparatus, such as the processor, the communication interface 16 or the like, may be configured to determine the relative position of the other device based upon the directionality of the signals provided by the other device and received by the communication interface of the apparatus In yet another embodiment, the apparatus, such as the processor, and the other devices may be configured to determine contextual information, such as one or more sensed features, e.g., position, location, orientation with respect to a fixed object, etc., with the relative position of the apparatus to each other device being determined based upon the contextual information. While certain embodiments of techniques for determining the relative position of one or more other devices with respect to the apparatus are described, other techniques may be employed by other embodiments of the present invention.

Though the above examples include one or more signals being sent between the apparatus and one or more other devices, embodiments of the present invention may be utilized with any indication of the relative position between the apparatus and one or more other devices, and are not meant to be limited to transmission and receipt of signals directly between the first and second device. For example, in some embodiments, the apparatus 10, such as the processor 12, the communication interface 16 or the like, and each other device may communicate with a network entity, such as a server, that is configured to determine the relative position of the each other device to the apparatus and to provide information regarding the relative position to the apparatus.

As shown in block 34 of FIG. 2, the apparatus 10 may also include means, such as the processor 12 or the like, for performing an operation based at least partially upon the position of the second device relative to the first device. Thus, the apparatus, such as the processor, may be configured to perform a first operation in response to the first and second devices having a first relative position, a second operation in response to the first and second devices having a second relative position, etc. The apparatus, such as the processor, may be configured to perform various types of operations including execution of an application, presentation of a predefined display, performance a particular function, such as the answering of a voice call or the forwarding of a voice call to voicemail or to another party, the opening of a file, the playing of a media file or the like.

Optionally, the apparatus 10 may also include means, such as the processor 12, the communication interface 18, or the like, for causing information to be transmitted to the second device. See block 36 of FIG. 2. In this regard, various types of information may be transmitted to the second device including an indication that the relative position of the first and second devices has been identified and a corresponding operation has or is being performed. Still further, the information provided to the second device may include information regarding the operation that is performed and/or a result generated by the performance of the operation. In one embodiment, for example, the performance of the operation may include the transfer of a file to the second device for execution thereon, such as the transfer of a media file from the first device to the second device such that the media file may be played by the second device.

In one embodiment, the apparatus 10 may be embodied by or otherwise included within the first device. However, any one of the devices for which the relative position is determined may be considered the first device and, as such, may include or otherwise embody the apparatus. With respect to the examples provided by FIGS. 3 and 4, the first device is embodied by the laptop computer 40 and the second device is embodied by the mobile telephone 42. However, the first device may be alternatively considered to be embodied by the mobile telephone and the second device may be considered to be embodied by the laptop computer. As such, although the apparatus of an example embodiment may be embodied by the first device, any one of the devices that are considered for purposes of determining the relative position may be considered the first device and may therefore include or otherwise embody the apparatus.

With reference to FIGS. 3 and 4 by way of example, the apparatus 10 may be embodied by the laptop computer 40 and may be configured to perform an operation associated with the execution of a media file. In this regard, the positioning of the second device embodied by a mobile telephone 42 proximate to but on the right side of the second device embodied by the laptop computer may cause the media file to be fast-forwarded. In an instance in which the second device embodied by the mobile telephone is moved further away from the first device embodied by the laptop computer, but remains on the right side of the first device as shown by the dashed outline in FIG. 3, the media file may be fast-forwarded at a greater rate, such as a double speed fast-forward, or the media file may be advanced by skipping to the next scene, the next track, etc. Continuing with this example, the placement of the second device embodied by the mobile telephone on the left side of the first device embodied by the laptop computer as shown in FIG. 4 may cause the media file to be rewound. As such, the relative positions of the first and second devices can cause various operations to be performed if in a manner that, in some embodiments, is intuitive and consequently memorable for the user.

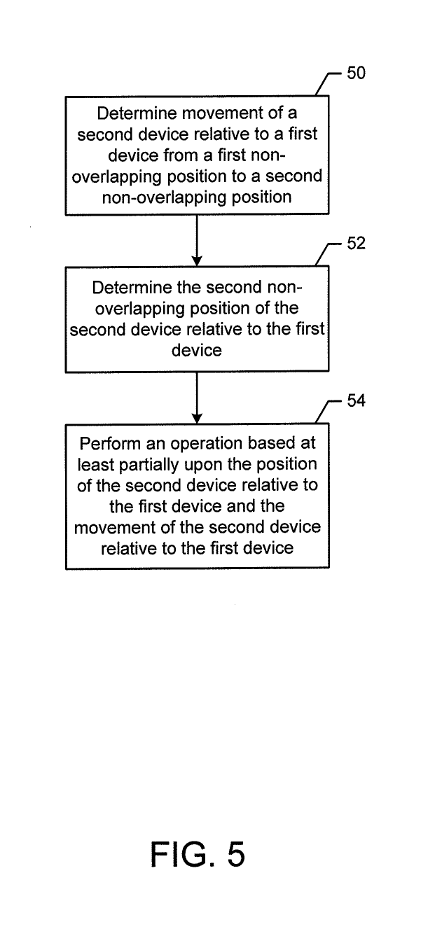

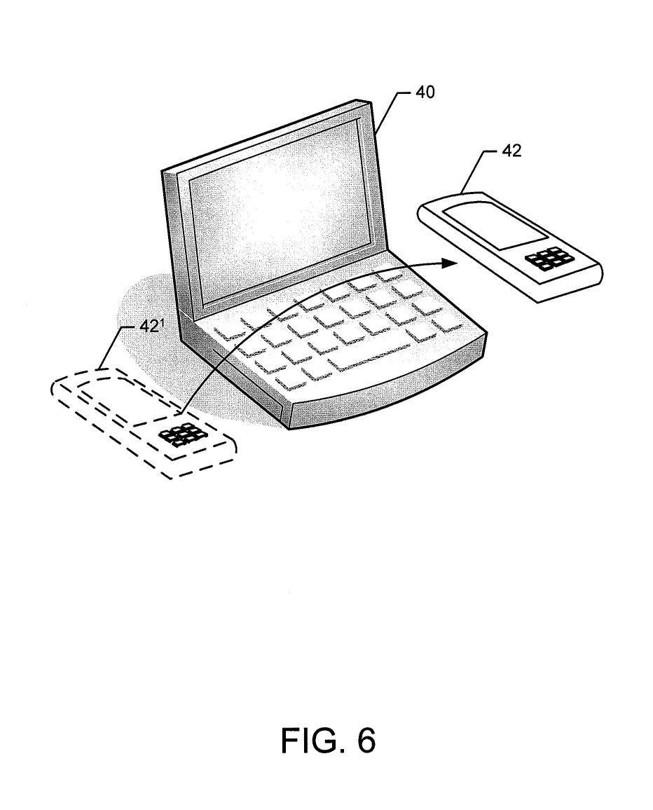

In one embodiment, the operation that is performed is not only based upon the relative positions of the first and second devices, but also upon other forms of user input. In the embodiment illustrated in FIG. 5, the apparatus 10 also include means, such as the processor 12, the sensor(s) 22 or the like, for determining movement of the second device relative to the first device from a first non-overlapping position to a second non-overlapping position. See operation 50 of FIG. 5. By way of example, FIG. 6 depicts a second device embodied by a mobile telephone that is moved from a first non-overlapping position 42′ to a second non-overlapping position 42 relative to first device embodied by a laptop computer 40. In this embodiment, the apparatus, such as the processor, the sensor(s) or the like, may not only determine the relative positions of the first and second devices, such as the placement of the second device embodied by the mobile telephone on the right side of the first device embodied by the laptop computer, but also the relative movement of the second device with respect to the first device in order to arrive at that position. The movement of the second device relative to the first device may be detected by one or more sensors carried by the second device, such as accelerometers, gyroscopes, position sensors, etc., with information regarding the movement of the second device being provided to the apparatus. As such, the apparatus of this embodiment may determine the movement of the second device relative to the first device based upon its receipt and analysis of the information provided by the second device indicative of the movement of the second device and its consideration of position information relating to the position of the first device provided, for example, by one or more position sensors. As shown in FIG. 6, the movement that is detected may be movement of a second device that causes the second device to overlie a portion of the first device during the movement event. For example, the movement that is detected in one embodiment may be movement of a second device that causes the second device to overlie the display of the first device during the movement event, while the movement that is detected in another embodiment may be movement of the second device that causes the second device to overlie the user interface of the first device, e.g., the display and the keypad in the embodiment of FIG. 6.

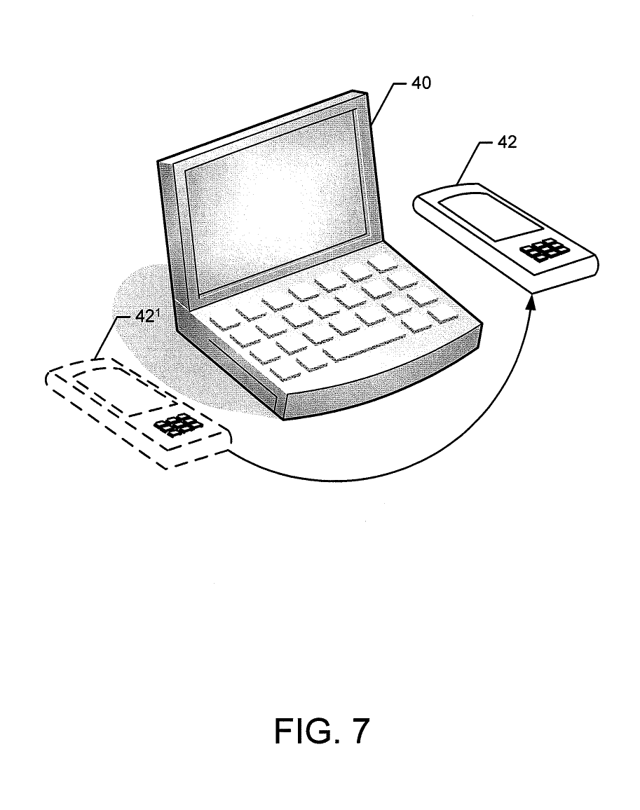

In another embodiment depicted, for example, in FIG. 7, the movement that is detected may be a non-overlapping movement of the second device relative to the first device.

In one embodiment, the non-overlapping movement may be a non-display-overlapping movement in which no portion of the second device overlies or otherwise overlaps any portion of the display of the first device during the movement event, while in another embodiment, the non-overlapping movement is a non-user interface-overlapping movement in which no portion of the second device overlies or otherwise overlaps any portion of the user interface of the first device, such as the keypad and display of the laptop computer 40 in FIG. 7, during the movement event. Still further, the non-overlapping movement may be defined in accordance with one embodiment so that no portion of the second device overlies any portion of the first device, as shown, for example, in FIG. 7 during the movement event.

As described above in conjunction with block 32 of FIG. 2, the apparatus 10 of this embodiment may also include means, such as the processor 12, the sensor(s) 22 or the like, for determining the non-overlapping position of the second device relative to the first device, following the movement of the second device. See block 52 of FIG. 5. As such, the apparatus of this embodiment may include means, such as the processor or the like, for performing an operation based at least partially upon the position of the second device relative to the first device and also based upon the movement of the second device relative to the first device. See block 54 of FIG. 5. Thus, the operation performed by the apparatus of this embodiment is not only dependent upon the relative position of the first and second devices, but also the movement between the first and second devices that brought the first and second devices into that relative position. By basing the performance of the operation upon not only the relative position of the first and second devices, but also relative movement between the first and second devices, the method, apparatus and computer program product of an example embodiment may provide a much greater variety of user inputs and, therefore, a much greater variety of operations that may be performed in response to respective ones of the user inputs. By way of example, the initial placement of the first device to the right side of the second device may cause the performance of a first operation, while the movement of the second device from the left side of the first device to the right side of the first device combined with the relative position of the second device on the right side of the first device may cause a second operation to be performed.

While the position of the second device is shown and described herein to be to the left or right of the first device and while the movement of the second device with respect to the first device is shown and described herein to be from the left side of the first device to the right side of the first device, the method, apparatus and computer program product of other embodiments may be configured to determine other relative positions and other types of movement between the first and second devices including movement in a vertical direction (either upwardly or downwardly), movement in a diagonal direction, movement in a clockwise or counter-clockwise direction, relative positions that are in a forward or rearward direction or the like.

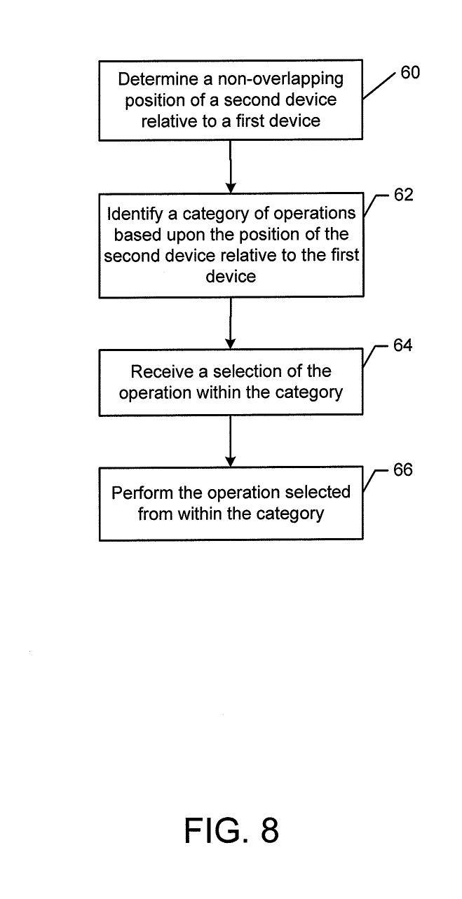

By way of example of an operation that may be performed in accordance with an example embodiment to the present invention, reference is now made to FIG. 8. As shown in block 60, the apparatus 10 may include means, such as the processor 12, the sensor(s) 22 or the like, for determining the non-overlapping position of the second device relative to the first device, such as described above in conjunction with block 32 of FIG. 2 and block 52 of FIG. 5. In this embodiment, the apparatus may also include means, such as the processor or the like, for identifying a category of operation based upon the position of the second device relative to the first device. See block 62 of FIG. 8. Thus, a first relative position of the first and second devices may cause a first category of operations to be identified, while a second relative position of the first and second devices may cause a second category of operations to be identified. Various categories of operations may be identified including, for example, a category of operations that relates to the playing of a media file and may include, for example, operations of play, rewind, fast-forward, double-speed fast-forward, skip to the next scene, stop, etc.

The apparatus 10 of this embodiment may also include means, such as the processor 12, the user interface 18, the user interface circuitry 20 or the like, for receiving a selection of an operation within the category. See block 64 of FIG. 8. This selection may be provided in various manners including by the user's selection of a key or provision of a touch input associated with the selected operation. Based upon the selection of the operation within the category, the apparatus may include means, such as the processor or the like, for performing the operation selected from within the category. See block 66. By utilizing the relative positions of the first and second devices in order to identify a category of operations and then relying upon further user input in order to select an operation within the category, the method, apparatus and computer program product of this example embodiment may provide an even greater array of choices to the user in a manner that is efficient and facilitated by the relative positions of the first and second devices.

As described above, FIGS. 2, 5 and 8 are flowcharts of a system, method, and computer program product according to an example embodiment of the invention. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the operations described herein may be embodied by computer program instructions of a computer program product. In this regard, the computer program product(s) which embody the operations described herein may be stored by one or more memory devices 14 and executed by a processor 12 of the apparatus 10. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

In some embodiments, certain ones of the operations above may be modified or further amplified. Furthermore, in some embodiments, additional optional operations may be included, such as by shown by blocks 30 and 36 having a dashed outline in FIG. 2. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
determining a position of a second device relative to a first device, wherein the position of the second device is non-overlapping relative to the first device; and
performing an operation, with a processor, based at least partially upon the position of the second device relative to the first device.

2. A method according to claim 1 further comprising determining movement of the second device relative to the first device from a first non-overlapping position to a second non-overlapping position, wherein performing the operation comprises performing the operation based at least partially upon the movement of the second device relative to the first device.

3. A method according to claim 1 further comprising causing information to be transmitted to the second device.

4. A method according to claim 1 wherein performing the operation comprises identifying a category of operations based upon the position of the second device relative to the first device, and wherein the method further comprises receiving a selection of the operation within the category and performing the operation selected from within the category.

5. A method according to claim 4 wherein identifying the category of operations comprises causes a plurality of candidate operations to be presented, and wherein receiving the selection comprises receiving the selection of a respective candidate operation.

6. A method according to claim 1 further comprising receiving a signal from the second device via a proximity-based communication protocol, and wherein determining the position of the second device relative to the first device comprises determining the position of the second device relative to the first device based at least partially upon the signal.

7. An apparatus comprising at least one processor and at least one memory storing computer program code, the at least one memory and the computer program code configured to, with the processor, cause the apparatus to at least:
determine a position of a second device relative to a first device, wherein the position of the second device is non-overlapping relative to the first device; and
perform an operation based at least partially upon the position of the second device relative to the first device.

8. An apparatus according to claim 7 wherein the at least one memory and the computer program code are further configured to, with the processor, cause the apparatus to determine movement of the second device relative to the first device from a first non-overlapping position to a second non-overlapping position, wherein the at least one memory and the computer program code are configured to, with the processor, cause the apparatus to perform the operation by performing the operation based at least partially upon the movement of the second device relative to the first device.

9. An apparatus according to claim 7 wherein the at least one memory and the computer program code are further configured to, with the processor, cause the apparatus to cause information to be transmitted to the second device.

10. An apparatus according to claim 7 wherein the at least one memory and the computer program code are configured to, with the processor, cause the apparatus to perform the operation by identifying a category of operations based upon the position of the second device relative to the first device, and wherein the at least one memory and the computer program code are further configured to, with the processor, cause the apparatus to receive a selection of the operation within the category and performing the operation selected from within the category.

11. An apparatus according to claim 10 wherein the at least one memory and the computer program code are configured to, with the processor, cause the apparatus to identify the category of operations by causing a plurality of candidate operations to be presented, and wherein the at least one memory and the computer program code are configured to, with the processor, cause the apparatus to receive the selection by receiving the selection of a respective candidate operation.

12. An apparatus according to claim 7 wherein the at least one memory and the computer program code are further configured to, with the processor, cause the apparatus to receive a signal from the second device via a proximity-based communication protocol, and wherein the at least one memory and the computer program code are configured to, with the processor, cause the apparatus to determine the position of the second device relative to the first device by determining the position of the second device relative to the first device based at least partially upon the signal.

13. An apparatus according to claim 7 wherein the apparatus is embodied by a mobile terminal.

14. An apparatus according to claim 13 further comprising a display and user interface circuitry arranged to facilitate user control of at least some functions of the mobile terminal through use of the display.

15. A computer program product comprising at least one non-transitory computer-readable storage medium having computer-executable program code portions stored therein, the computer-executable program code portions comprising program instructions configured to:
determine a position of a second device relative to a first device, wherein the position of the second device is non-overlapping relative to the first device; and
perform an operation based at least partially upon the position of the second device relative to the first device.

16. A computer program product according to claim 15 wherein the computer-executable program code portions further comprise program instructions configured to determine movement of the second device relative to the first device from a first non-overlapping position to a second non-overlapping position, wherein the program instructions configured to perform the operation comprise program instructions configured to perform the operation based at least partially upon the movement of the second device relative to the first device.

17. A computer program product according to claim 15 wherein the computer-executable program code portions further comprise program instructions configured to cause information to be transmitted to the second device.

18. A computer program product according to claim 15 wherein the program instructions configured to perform the operation comprise program instructions configured to identify a category of operations based upon the position of the second device relative to the first device, and wherein the program instructions configured to perform the operation comprise program instructions configured to receive a selection of the operation within the category and perform the operation selected from within the category.

19. A computer program product according to claim 18 wherein the program instructions configured to identify the category of operations comprise program instructions configured to cause a plurality of candidate operations to be presented, and wherein the program instructions configured to receive the selection comprise program instructions configured to receive the selection of a respective candidate operation.

20. A computer program product according to claim 15 wherein the computer-executable program code portions further comprise program instructions configured to receive a signal from the second device via a proximity-based communication protocol, and wherein the program instructions configured to determine the position of the second device relative to the first device comprise program instructions configured to determine the position of the second device relative to the first device based at least partially upon the signal.
